(19) United States
(12) Patent Application Publication
(10) Pub. No.: US 2019/0295205 A1
(43) Pub. Date: Sep. 26, 2019

(54) INFORMATION PROCESSING APPARATUS AND PROGRAM

(71) Applicant: Toyota Jidosha Kabushiki Kaisha, Toyota-shi Aichi-ken (JP)

(72) Inventors: Koichiro Mitsumaki, Toyota-shi Aichi-ken (JP); Masato Endo, Toyota-shi Aichi-ken (JP); Ryota Kondo, Toyota-shi Aichi-ken (JP); Yasuhisa Obata, Toyota-shi Aichi-ken (JP)

(21) Appl. No.: 16/359,196

(22) Filed: Mar. 20, 2019

(30) Foreign Application Priority Data
Mar. 22, 2018 (JP) 2018-054951

(51) Int. Cl. G06Q 50/30; G01C 21/34

(52) U.S. Cl. CPC G06Q 50/30; G01C 21/3438

(57) ABSTRACT

An information processing apparatus is provided that includes: a registration part that receives registration of a particular vehicle type and color from a user and stores the particular vehicle type and color as specified vehicle information; a vehicle place acquisition part that acquires a specified place where a vehicle according to the specified vehicle information is available; a positional information acquisition part that acquires positional information of the user; a judgment part that judges whether a distance between the specified place and a position indicated by the positional information is within a predetermined range, based on information acquired by the vehicle place acquisition part and the positional information acquisition part; and a notification part that notifies the user that the vehicle according to the specified vehicle information is available when the judgment part judges that the distance is within the predetermined range.

### CROSS-REFERENCES TO RELATED APPLICATIONS

This application relates to and claims priority from Japanese Patent Application No. JP2018-054951, filed on Mar. 22, 2018, the entire disclosure of which is incorporated herein by reference.

### BACKGROUND

### Field

The present disclosure relates to an information processing apparatus and program.

### Description of Related Art

Today, car sharing services are widespread and a plurality of users can share a vehicle through such systems. For example, according to a car sharing and reservation system described in JP2011-209960 A, users are prompted to record their favorite information in the system in advance, indicating their favorite vehicle colors, types, etc., so that a vehicle reservation screen is able to display currently available vehicles by putting priority on vehicles that match each user's recorded favorite information.

The system described in JP2011-209960 A enables each user to record particular colors or types of vehicles in the system in advance, according to the user's preference. However, if the user's recorded vehicles are already booked at the time when the user actually searches for an available vehicle, the user is unable to rent the vehicles. In order to make the car sharing market more active, the development of technology is demanded so that each user can conveniently use the user's recorded vehicles at any time when the user wishes to use the car sharing service.

### SUMMARY

In view of the above-described circumstances, an object of the present disclosure is to provide a technique for increasing the opportunities for users to be able to use a vehicle that matches each user's preferences recorded in a car sharing system.

An information processing apparatus according to an aspect of the present disclosure comprises: a registration part that receives registration of a particular vehicle type and color from a user and stores the particular vehicle type and color as specified vehicle information; a vehicle place acquisition part that acquires a specified place where a vehicle according to the specified vehicle information is available; a positional information acquisition part that acquires positional information of the user; a judgment part that judges whether a distance between the specified place and a position indicated by the positional information is within a predetermined range, based on information acquired by the positional information acquisition part and the vehicle place acquisition part; and a notification part that notifies the user that the vehicle according to the specified vehicle information is available when the judgment part judges that the distance is within the predetermined range.

The present disclosure provides a technique for increasing the opportunities for users to be able to use a vehicle that matches each user's preference recorded in a car sharing system.

### BRIEF DESCRIPTION OF DRAWINGS

FIG. 1 illustrates an example of the configuration of a car sharing system according to an embodiment.

FIG. 2 illustrates an example of the functional block configuration of an information processing apparatus.

FIGS. 3A and 3B show specific examples of a user database and a specified vehicle database, respectively.

FIGS. 4A and 4B show specific examples of a positional information database and a vehicle information database, respectively.

FIG. 5 illustrates an example of processing steps performed by an information processing apparatus.

FIG. 6 is an illustration for explaining an operation example.

### DETAILED DESCRIPTION

Hereinafter, embodiments of the present disclosure will be described with reference to the attached drawings. In the drawings, elements given the same reference numeral have the same or similar configurations.

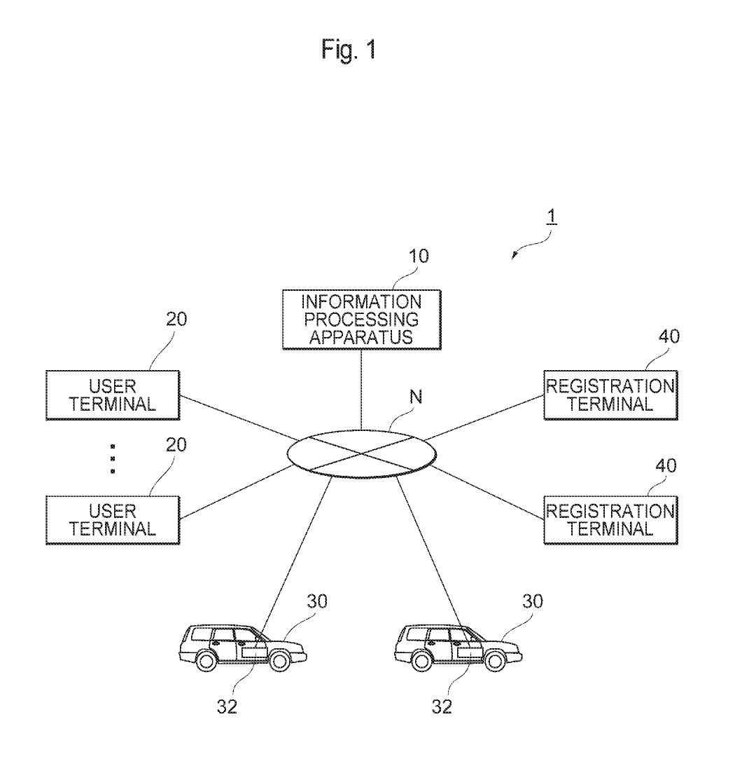

System Configuration FIG. 1 illustrates an example of the configuration of a car sharing system 1 according to an embodiment. The car sharing system 1 includes an information processing apparatus 10, user terminals 20, vehicles 30, and registration terminals 40. Each of the vehicles 30 is equipped with an in-vehicle device 32. The information processing apparatus 10, the user terminals 20, the in-vehicle devices 32, and the registration terminals 40 can communicate with each other via a communication network N.

The car sharing system 1 is configured to be able to: receive registration of predetermined information by a user; acquire a place where a vehicle according to the user's registered information is available; and notify the user that a registered vehicle of the user is available. It should be noted here that the term “car sharing” generally means that a vehicle 30 is shared by a plurality of users.

The information processing apparatus 10 receives registration of a particular vehicle type, color, etc., from a user, and acquires a place where a vehicle according to such information registered by the user is available. The information processing apparatus 10 also acquires positional information of the user. When the distance between the position of the user and the place of the available vehicle is within a predetermined range, the information processing apparatus 10 notifies the user of such available vehicle via the user terminal 20. The information processing apparatus 10 may be configured by one or more information processing apparatuses, or may be configured by a cloud server or virtual server.

The user terminal 20 is a terminal device that the user of the car sharing system 1 uses, and examples include a smartphone, a tablet, a portable device and a notebook PC. The user can register information entered through the user terminal 20 in the information processing apparatus 10, and can also register the user's positional information in the information processing apparatus 10. Furthermore, the user can register information on the type, color, etc., of vehicles that the user is going to use (e.g., the user's favorite vehicle type and color, or the type and color of a vehicle that the user is going to use at a specific scheduled date and time), in advance, in the information processing apparatus 10 through using the user terminal 20. With this registration, when the user actually wishes to use the car sharing system 1, the user can easily search for a vehicle that matches the user's preference, by designating the vehicles previously registered by the user.

The vehicle 30 is a vehicle that is used by users, and includes both private vehicles and vehicles owned by companies. The vehicle 30 is not particularly limited, as long as users can drive or ride in the vehicle and move with the vehicle by freely selecting the driving route. Specifically, the vehicle 30 may be a vehicle that is rented by a company for car sharing, or may be a taxi or a privately owned vehicle. The vehicle 30 is not limited to being a car. For example, the vehicle 30 may be a large-size vehicle in which more than ten passengers to several tens of passengers can ride, such as a bus, or it may be a motorcycle. Further, the vehicle 30 may be a vehicle that the user operates by holding a steering wheel (hereinafter also called a “manually operated vehicle”), or a vehicle that can be operated without a driver (hereinafter also called an “autonomous vehicle”).

When the vehicle 30 is a manually operated vehicle, the in-vehicle device 32 may be a device (e.g., a navigation device) that can display a route for driving to a destination directed by the information processing apparatus 10. When the vehicle 30 is an autonomous vehicle, the in-vehicle device 32 performs various controls so that the vehicle 30 drives autonomously according to a route for driving to the position of the user, that is sent from the information processing apparatus 10.

The registration terminal 40 is a terminal device used by the owner of a vehicle who rents the vehicle, and examples include a smartphone, a tablet, a portable device, and a notebook PC. The registration terminal 40 displays, for example, a screen for making a registration as an owner of a vehicle in the car sharing system 1 and a screen for setting the conditions for renting the vehicle. By entering information according to the instructions in the screens, the owner can complete the procedures for registration as an owner, the procedures for renting the vehicle, etc.

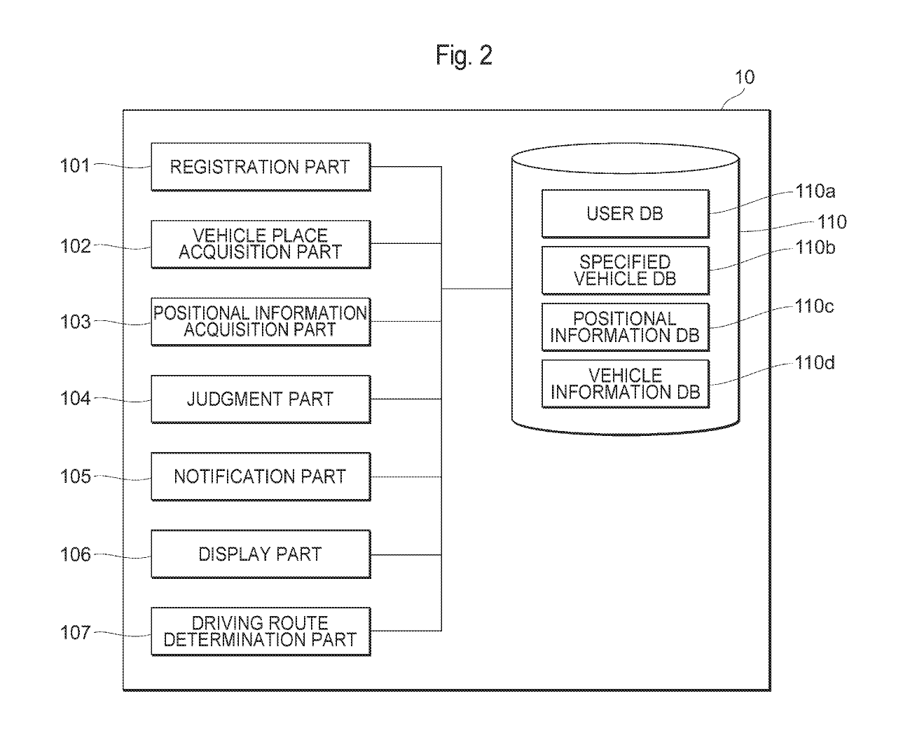

Functional Block Configuration FIG. 2 shows an example of the functional block configuration of the information processing apparatus 10. The information processing apparatus 10 includes a registration part 101, a vehicle place acquisition part 102, a positional information acquisition part 103, a judgment part 104, a notification part 105, a display part 106, a driving route determination part 107 and a storage part 110. It should be noted here that the information processing apparatus 10 of the embodiment may have at least part of the functions shown in FIG. 2, instead of having all of the functions in FIG. 2.

The registration part 101, the vehicle place acquisition part 102, the positional information acquisition part 103, the judgment part 104, the notification part 105, the display part 106, and the driving route determination part 107 can be implemented by the CPU of the information processing apparatus 10 executing programs stored on the memory. Such programs may also be stored on a storage medium. A storage medium storing such programs may be a non-transitory storage medium. A non-transitory storage medium is not particularly limited, and examples thereof may include a USB memory and a CD-ROM. The storage part 110 can be implemented by a memory or a storage device provided in the information processing apparatus 10.

The storage part 110 stores a user database (user DB) 110a, a specified vehicle database (specified vehicle DB) 110b, a positional information database (positional information DB) 110c, and a vehicle information database (vehicle information DB) 110d. The user DB 110a stores information about users who have signed up for the car sharing system 1. The specified vehicle DB 110b stores information about vehicles registered by the users, including information on a particular type and color of the vehicles. The positional information DB 110c stores positional information indicating the position of each user at a particular point in time, or positional information registered in advance by the user. The vehicle information DB 110d stores information about various vehicles 30, including the type and color of the vehicles, as well as the location of storage of each vehicle 30, information about the reservation of each vehicle 30, etc., in association with the above information about the vehicles 30.

The registration part 101 receives registration of a particular vehicle type and color from the user, and stores information of the registered vehicle (hereinafter also referred to as “specified vehicle information”) in the specified vehicle DB 110b. The information that is stored in the specified vehicle DB 110b by the registration part 101 is not limited to the above-described specified vehicle information, but also includes text information input by the user (as a free text data entry). In addition to the registration of the vehicles selected by the users themselves, the registration part 101 further stores, in the specified vehicle DB 110b, vehicles that should be recommended for the users based on the text information entered by the users. The “vehicle according to the specified vehicle information,” as referred to herein, includes not only the vehicles selected by each user, but also includes vehicles that should be recommended for each user based on the text information input by the user.

The vehicle place acquisition part 102 extracts, from the vehicle information DB 110d, the place of storage (hereinafter also referred to as the “specified place”) where the vehicle according to the specified vehicle information is available, and stores the extracted place in the specified vehicle DB 110b.

The positional information acquisition part 103 acquires the position where each of the users registered in the user DB 110a is in at a particular point in time, and stores the acquired position in the positional information DB 110c. The user's positional information acquired by the positional information acquisition part 103 may be, for example, information on the current position of each user, or may be information on a position registered by the user in advance.

The judgment part 104 refers to the positional information DB 110c in which each user's positional information acquired by the positional information acquisition part 103 is stored, and the specified vehicle DB 110b in which the specified place extracted by the vehicle place acquisition part 102 is stored, and, based on the information in such databases, judges whether the distance between the position indicated by the positional information and the specified place falls within a predetermined range. The predetermined range is set as appropriate in the present embodiment. The range may be set in advance by the information processing apparatus 10. Alternatively, each user may be allowed to register a particular range for the user. The predetermined range may be set at a value that enables the user to readily use the user's registered vehicle when such vehicle is searched for by the user and found available.

When the judgment part 104 judges that the distance between the user's position acquired by the positional information acquisition part 103 and the specified place acquired by the vehicle place acquisition part 102 is within the predetermined range, the notification part 105 notifies the user that a vehicle according to the specified vehicle information is available. Examples of the means for notifying the user include providing a representation on the user terminal 20, indicating that a vehicle according to the specified vehicle information is available. The means for notifying the user is not limited to the above, and may be modified in various ways.

It should be noted here that the judgment part 104 may also have the function of judging whether the vehicle 30 that has been extracted by the vehicle place acquisition part 102 as an available vehicle is a self-driving vehicle that can drive without a driver. Further, the notification part 105 may also have the function of notifying the user that the available vehicle judged by the judgment part 104 is a self-driving vehicle.

The display part 106 outputs instructions to display information about a particular vehicle on the user terminal 20 when the user searches for the particular vehicle through the car sharing system 1. As already described above, the registration part 101 is able to receive entries of text data from the user, in addition to entries of a particular vehicle type and color. When such entry of text data is received, the display part 106 outputs instructions to display information related to the text data entry on the user terminal 20.

The driving route determination part 107 determines a driving route that a particular vehicle 30 should follow when the user wishes to use the particular vehicle 30 through the car sharing system 1. The driving route that the vehicle 30 should follow may be, for example, a route from the storage place of the vehicle 30 to the current position of the user, or a route to a position indicated by the information registered by the user (e.g., the user's home). The driving route determination part 107 may also have the function of determining the route for driving from the place where the vehicle is available (e.g., the storage place of the vehicle) to the user's position acquired by the positional information acquisition part 103, when the judgment part 104 judges that the available vehicle is a self-driving vehicle.

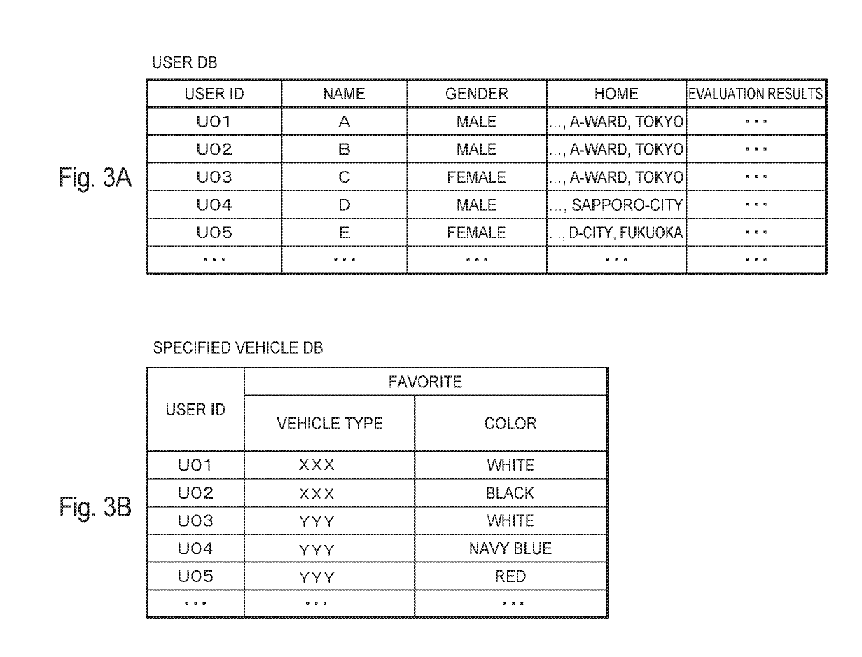

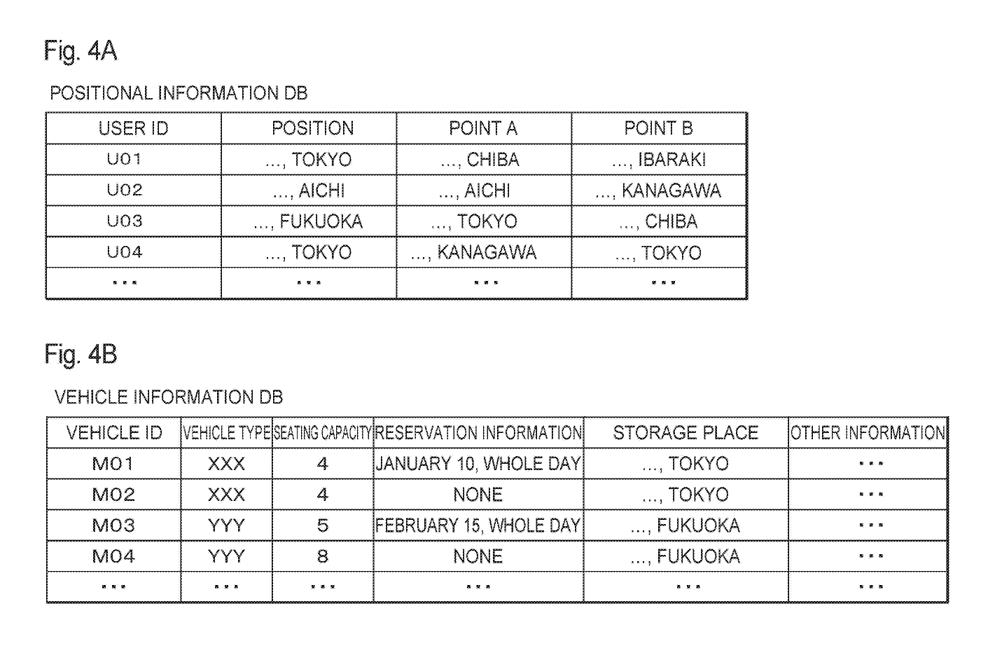

Next, specific examples of the user DB 110a, the specified vehicle DB 110b, the positional information DB 110c, and the vehicle information DB 110d will be described with reference to FIGS. 3A, 3B, 4A and 4B.

FIG. 3A shows a specific example of the user DB 110a. The “User ID” field stores a unique identifier of each user for identifying the user in the car sharing system 1. For example, the user ID may be assigned by the information processing apparatus 10 when the user signs up for the car sharing system 1 to use the system (such signing-up for the system will hereinafter be simply referred to as “signing-up”). The “Name” field stores the user's name entered at the time of signing-up. The “Gender” field stores the user's gender entered at the time of signing-up. The “Home” field stores information indicating the location of the user's home (such as the address, the latitude and longitude, etc.) entered at the time of signing-up. The “Evaluation Results” field stores information indicating the user's evaluation about the vehicle in the previous use of the car sharing system 1. The user's evaluation may be made based on, for example, two grades: “Want to use again” and “Do not want to use again.” The method of evaluation is not limited to the above, and three or more grades may be employed for the evaluation. In the case where the user has used several types of vehicles 30, the user may compare the vehicles and evaluate each of them. The “Evaluation Results” field may also store the average of the previous evaluation results, or store the history of the previous evaluation results (such as the history including the results of each evaluation together with the date when the evaluation was made). Each user can search the evaluation results entered by other users, and may, for example, use such evaluation results for purchasing the user's own vehicle.

FIG. 3B shows a specific example of the specified vehicle DB 110b. The “User ID” field is the same as the one in the user DB 110a, and the description thereof will be omitted here. The “Favorite” field stores information about the user's favorite vehicles that each user has entered into the information processing apparatus 10 through the user terminal 20. Such information about the favorite vehicles includes a particular “vehicle type” and “color.” Information stored in the “Favorite” field is not limited to the information shown in FIG. 3B, and may also include text information input by the user (as a free text data entry), as already described above.

FIG. 4A shows a specific example of the positional information DB 110c. The “User ID” field is the same as the one in the user DB 110a, and the description thereof will be omitted here. The “Position” field stores, for example, the current position of the user that has been acquired by the positional information acquisition part 103. The “Point A” and “Point B” fields each store information about a place that has been entered into the information processing apparatus 10 by the user through the user terminal 20. For example, the user's desired starting and destination points may be registered in the “Point A” and “Point B” fields.

FIG. 4B shows a specific example of the vehicle information DB 110d. The “Vehicle ID” field stores a unique identifier for identifying each vehicle 30 in the car sharing system 1. Such vehicle ID may be, for example, the license plate number of the vehicle 30. The “Vehicle Type” field stores the type and manufacturer of the vehicle 30. The “Seating Capacity” field stores the number of passengers that the vehicle 30 can hold. The “Reservation Information” field stores a time period during which the vehicle 30 is reserved (i.e., the vehicle 30 is not available). The “Storage Place” field stores information indicating the place where the vehicle 30 is parked. The storage place may also be referred to as a renting station for the vehicle 30, since the storage place also serves as a place where the user can get in the vehicle 30 (i.e., the place where the vehicle is available). The “Other Information” field stores other additional information as needed. For example, the owner of the vehicle 30 (i.e., the person who rents the vehicle 30 to the users) may register information related to the vehicle 30 (e.g., advantageous points of the vehicle 30).

The information registered by the owner may be displayed on the user terminal 20 when the user conducts a search in the car sharing system 1, and such displayed information may be updated according to the searched conditions by the user (for example, the characteristics that the user has entered as keywords for the search). Furthermore, the information in the “Other Information” field may be displayed on the user terminal 20 only when such information matches the searched conditions by the user.

Processing Steps

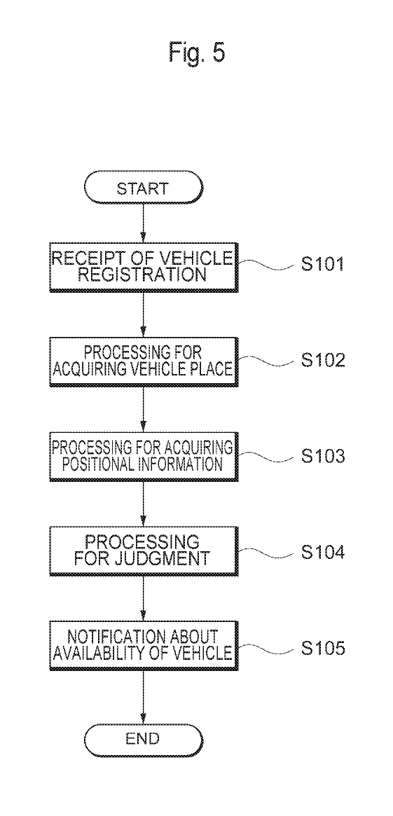

Next, each step of the processing performed by the information processing apparatus 10 will be described. FIG. 5 shows an example of the processing steps performed by the information processing apparatus 10.

In step S101, the registration part 101 receives, from the user terminal 20 of a user who has already signed up for the car sharing system 1, information about a particular vehicle type and color, and stores the received information in the specified vehicle DB 110b. The registration part 101 may prompt the user terminal 20 of a user who wishes to register a particular vehicle type and color, to display a screen for receiving the registration. By entering information including a particular vehicle type and color in the screen, the user can register the user's desired vehicles in the information processing apparatus 10, from among the vehicles stored in the storage part 110.

It should be noted here that the information stored in the specified vehicle DB 110b by the registration part 101 may also include text information input by the user (as a free text data entry), in addition to the information regarding the vehicle. In addition to the registration of the vehicle selected by the user, the registration part 101 also stores, in the specified vehicle DB 110b, vehicles that should be recommended for the user based on such text information input by the user. With this configuration, by entering the user's registered text information in the screen displayed on the user terminal 20, the user can search for a desired vehicle 30, and this leads to the provision of a system that is also convenient for users who are not familiar with car sharing systems.

In step S102, the vehicle place acquisition part 102 acquires a place where there is an available vehicle 30 according to the specified vehicle information registered by the user, including information on a particular vehicle type and color. Specifically, by referring to, for example, information stored in the “Reservation Information” field and the “Storage Place” field of the vehicle information DB 110d (FIG. 4B), the vehicle place acquisition part 102 acquires a place or places where a vehicle 30 according to the registered information in the specified vehicle DB 110b (FIG. 3B) (including text information input by the user) is available. The place where a vehicle 30 according to the specified vehicle information is available varies along with the information input by the user (e.g., the date and place at which the user wishes to use the vehicle 30, a particular vehicle type and color, and text information input by the user) and the positional information of the user, which will be described later, and such varying available places are displayed on the user terminal 20.

In step S103, the positional information acquisition part 103 acquires the positional information of the user. Such positional information may be the current position of the user, or may be a desired position that has been input in advance by the user (e.g., the user's home stored in the user DB 110a, or any place where the user is going to be in (the starting point and destination point, etc.)).

In step S104, the judgment part 104 refers to the positional information of the user acquired by the positional information acquisition part 103 and the specified place (i.e., the place where a vehicle 30 according to the specified vehicle information is available) acquired by the vehicle place acquisition part 102, and judges whether the distance between the acquired user position and the specified place is within a predetermined range. Such range is not particularly limited, and may be, for example, within a one kilometer radius. Alternatively, a judgment may be made as to whether the two points are in the same administrative district (e.g., in the same municipal area). A predetermined range as set forth above may be registered in advance by the information processing apparatus 10, or may be set by the user. Furthermore, such range may be configured to be modified according to the information input by the user.

In step S105, if the judgment part 104 judges that the distance between the user position and the specified place falls within the predetermined range, the notification part 105 notifies the user that a vehicle 30 according to the specified vehicle information is available. The means for notifying the user is not particularly limited. For example, such notification to the user may be displayed on the user terminal 20. The content of the notification by the notification part 105 to the user needs to include at least information from which the user can understand that the vehicle 30 registered by the user in advance is available, and may also include other information related to the vehicle 30. Examples of such other information related to the vehicle 30 include information in the “Evaluation Results” field that has been input by other users regarding the vehicle 30, and information about the vehicle 30 that has been registered in advance by the owner of the vehicle 30. With the notification as described above, the user can become aware of whether a vehicle 30 according to the information registered by the user is available, and this increases the opportunities for the user to be able to use a vehicle 30 that matches the user's preference.

Operation Example

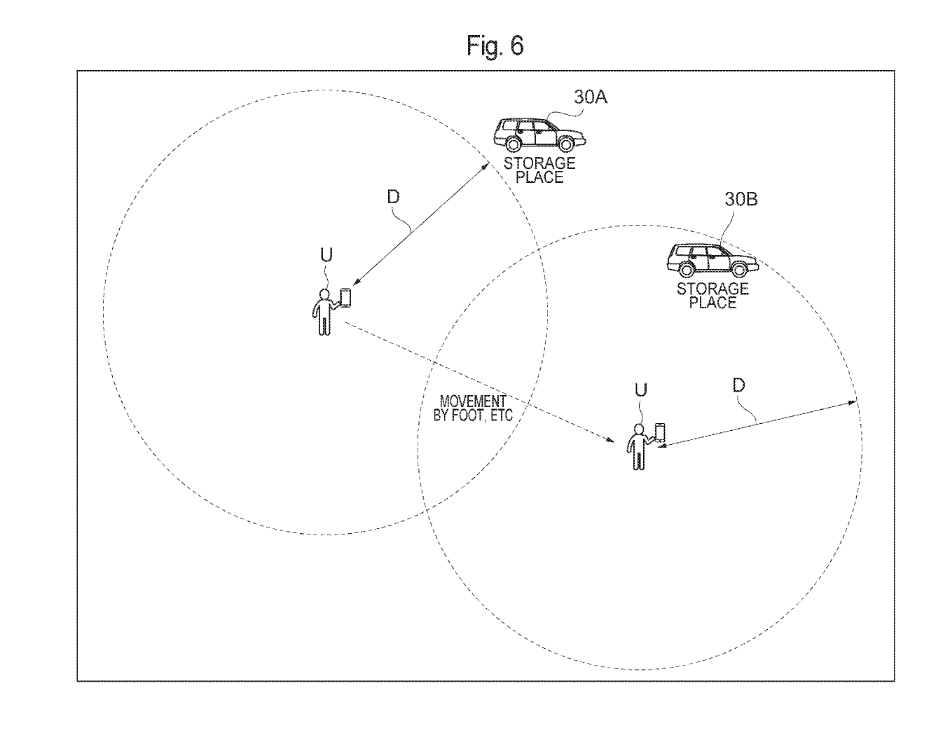

Next, an example of the operation performed by the car sharing system 1 will be described by referring to FIG. 6. The below description will be made by assuming that the user DB 110a, the specified vehicle DB 110b, the positional information DB 110c and the vehicle information DB 110d already store data as shown in FIGS. 3A, 3B, 4A and 4B, respectively.

FIG. 6 is an illustration describing a situation in which a user U has moved from one point to another and the user U after the movement is located close to a vehicle 30A or a vehicle 30B, each being a vehicle registered by the user U in advance.

First, the judgment part 104 of the information processing apparatus 10 judges whether vehicles 30A and 30B, each being registered by the user U in advance, are located within a predetermined range (for example, within a radius (D) of 5 kilometers) from the user U before the movement (i.e., the user located on the left side in FIG. 6), the position of such user U before the movement already being stored in the positional information DB 110c. Since the user U's registered vehicles 30A and 30B are not located in the vicinity of the user U before the movement, as illustrated in FIG. 6, the notification part 105 of the information processing apparatus 10 does not notify the user U that the vehicle 30A or 30B is available.

Then, when the user U has moved, the judgment part 104 of the information processing apparatus 10 judges whether the vehicles 30A and 30B, each being registered by the user U in advance, are located within a predetermined range from the user U after the movement (i.e., the user located on the right side in FIG. 6), the position of such user U after the movement already being stored in the positional information DB 110c. Since the user U's registered vehicle 30B is located in the vicinity of the user U after the movement, as illustrated in FIG. 6, the notification part 105 of the information processing apparatus 10 notifies the user U that the vehicle 30B is available. The notification part 105 may notify the user U by, for example, displaying such notification on the terminal of the user U.

FIG. 6 describes an example in which the user U is notified if the user U's registered vehicle 30A or 30B is judged, based on the positional information of the user U before and after the movement, as existing within a distance D (e.g., in a one-kilometer radius) from the user U. However, the present disclosure is not limited to such example shown in FIG. 6. For example, the user U may be notified if the vehicle 30A or 30B and the user U are in the same administrative district (e.g., the same municipal area). Alternatively, the user U may be notified if the vehicle 30A or 30B exists in the vicinity of a particular point that the user U has entered in advance (e.g., the user's home, the places where the user is going to be in (the start point, the destination point, etc.)). The user U may also be notified in the event of the availability of any vehicle, other than the vehicle 30A or 30B, that should be recommended for the user U based on the information input by the user U. The present disclosure can be implemented in other various modified embodiments, as long as such embodiments increase the opportunities for the user to be able to use vehicles, in accordance with the information related to vehicles that has been input in advance by the user.

The above-described embodiments are provided just for facilitating the understanding of the present disclosure, and should not be interpreted to limit the present disclosure. The flowchart and sequence described in the embodiments, each element provided in the embodiments, and the arrangement, material, conditions, shape and size, etc., of such element, are not limited to those described above, and may be modified as appropriate. Moreover, elements in different embodiments may be partly exchanged or combined.

What is claimed is:

1. An information processing apparatus comprising:
a registration part that receives registration of a particular vehicle type and color from a user, and stores the particular vehicle type and color as specified vehicle information;
a vehicle place acquisition part that acquires a specified place where a vehicle according to the specified vehicle information is available;
a positional information acquisition part that acquires positional information of the user;
a judgment part that judges whether a distance between the specified place and a position indicated by the positional information is within a predetermined range, based on information acquired by the positional information acquisition part and the vehicle place acquisition part; and
a notification part that notifies the user that the vehicle according to the specified vehicle information is available when the judgment part judges that the distance is within the predetermined range.

2. The information processing apparatus according to claim 1, wherein:
the vehicle according to the specified vehicle information includes a vehicle other than a vehicle indicated by the specified vehicle information, in accordance with information about the particular vehicle type and color registered by the user; and
the notification part also notifies the user about the vehicle other than the vehicle indicated by the specified vehicle information.

3. The information processing apparatus according to claim 1, wherein:
the registration part is able to receive registration of a text data entry from the user, other than the registration of the particular vehicle type and color; and
the information processing apparatus further comprises a display part that displays information about a vehicle according to the text data entry when the text data entry is received.

4. The information processing apparatus according to claim 1, wherein:
the judgment part also judges whether an available vehicle that has been acquired by the vehicle place acquisition part is a self-driving vehicle; and
the notification part also notifies the user that the available vehicle judged by the judgment part is a self-driving vehicle.

5. The information processing apparatus according to claim 1, further comprising a determination part that determines, when the judgment part judges that the available vehicle is a self-driving vehicle, a driving route for driving from the specified place where the vehicle is available to a position of the user acquired by the positional information acquisition part.

6. A program for causing a computer to perform the steps of:
receiving registration of a particular vehicle type and color from a user, and storing the particular vehicle type and color as specified vehicle information;
acquiring a specified place where a vehicle according to the specified vehicle information is available;
acquiring positional information of the user;
judging whether a distance between the specified place and a position indicated by the positional information is within a predetermined range; and
notifying the user that the vehicle according to the specified vehicle information is available when the distance is within the predetermined range.
